(19) United States
(12) Patent Application Publication
(10) Pub. No.: US 2006/0284541 A1
(43) Pub. Date: Dec. 21, 2006

(54) Electron beam chargeable reflector

(75) Inventors: Kenneth James Faase, Corvallis, OR (US); Michael J. Regan, Corvallis, OR (US); William R. Boucher, Corvallis, OR (US); Martha A. Truninger, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/153,073

(22) Filed: Jun. 15, 2005

(51) Int. Cl. H01J 29/00

(52) U.S. Cl. 313/364

(57) ABSTRACT

A reflective member is formed and spaced from a provided partial reflective layer. The reflective member is movable relative to the partial reflective layer. The reflective member is electrically coupled to a surface configured to be impinged by an electron beam

### BACKGROUND

Fabry-Perot interferometric devices may include multiple pixels which, upon being appropriately charged, may be used to form images in a display. Charging the individual pixels is sometimes performed using integrated circuitry which may be complex and costly.

### BRIEF DESCRIPTION OF THE DRAWINGS

FIG. 1 is a schematic illustration of a projection system according to one example embodiment.

FIG. 2 is a schematic illustration of one example of a pixel of a light modulator of the projection system of FIG. 1 according to an example embodiment.

FIG. 3 is a perspective sectional view of one example of the pixel of FIG. 2 according to an example embodiment.

FIG. 4 is a sectional view of the portion of the pixel taken along line 4-4 according to an example embodiment.

FIG. 5 is a sectional view of the pitch of FIG. 3 taken along line 5-5 according to an example embodiment.

FIG. 6 is a fragmentary top plan view of a portion of the pixel of FIG. 3 including a substrate, hide layer and first dielectric layer according to one example embodiment.

FIG. 7 is a fragmentary top perspective view of the portion of FIG. 6 with the addition of resistors and a second dielectric layer according to one example embodiment.

FIG. 8 is an enlarged fragmentary top plan view of the portion of FIG. 7 according to an example embodiment.

FIG. 9 is a fragmentary top plan view of the portion of FIG. 7 illustrating the addition of a partial reflector according to one example embodiment.

FIG. 10 is a sectional view of the portion of FIG. 9 taken along line 10-10 according to an example embodiment.

FIG. 11 is a sectional view of the portion of FIG. 9 taken along line 10-10 according to an example embodiment.

FIG. 12 is a fragmentary top plan view of the portion of FIG. 11 illustrating the addition of a first sacrificial layer according to an example embodiment.

FIG. 13 is a sectional view of the portion of FIG. 12 taken along line 13-13 according to an example embodiment.

FIG. 14 is a fragmentary top plan view of the portion of FIG. 12 illustrating the addition of flexures according to an example embodiment.

FIG. 15 is a sectional view of the portion of FIG. 14 taken along line 15-15 according to an example embodiment.

FIG. 16 is a fragmentary top plan view of the portion of FIG. 14 illustrating the addition of a reflective member and shield supports according to an example embodiment.

FIG. 17 is a sectional view of the portion of FIG. 16 taken along line 17-17 according to an example embodiment.

FIG. 18 is a fragmentary top plan view of the portion of FIG. 16 with the addition of a second sacrificial layer according to an example embodiment.

FIG. 19 is a sectional view of the portion of FIG. 18 taken along line 19-19 according to an example embodiment.

FIG. 20 is a fragmentary top plan view of the portion of FIG. 18 with the addition of a shield according to an example embodiment.

FIG. 21 is a sectional view of the portion of FIG. 20 taken along line 21-21 according to an example embodiment.

FIG. 22 is a sectional view of another embodiment of the pixel of FIG. 3 according to an example embodiment.

FIG. 23 is a fragmentary sectional view of another embodiment of the pixel of FIG. 3 according to an example embodiment.

### DETAILED DESCRIPTION OF EXAMPLE EMBODIMENTS

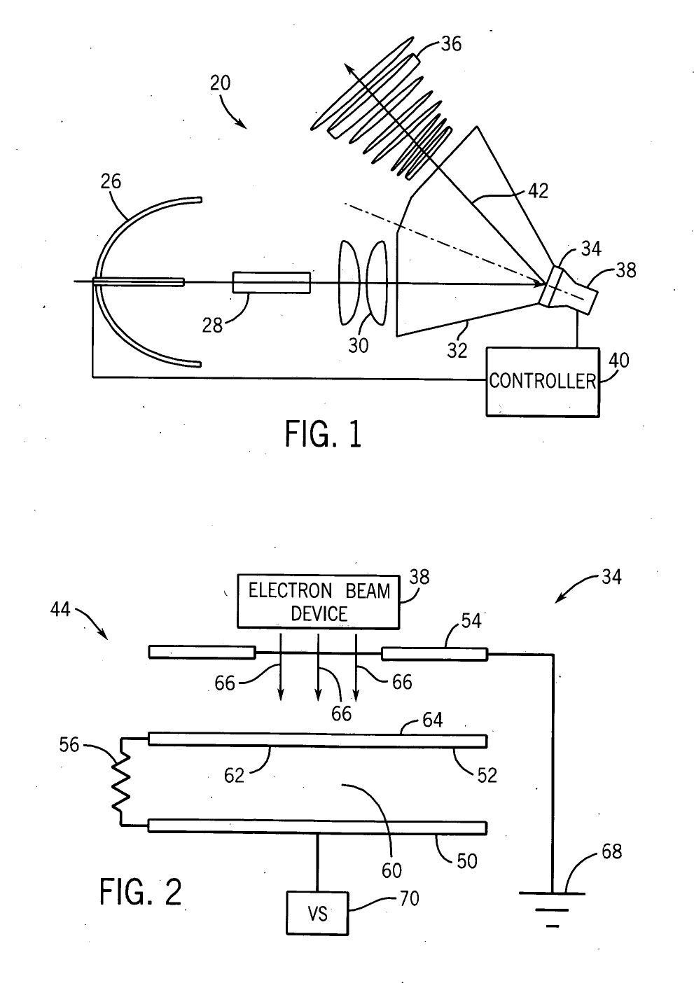

FIG. 1 schematically illustrates one example of an electronic device (shown as a display system 20). Display system 20 generally includes light source 26, integrator 28, condenser lens 30, prism 32, light modulator 34, projection lens 36, electron beam emitting device 38 and controller 40. Light source 26 directs light towards modulator 34. Integrator 28 integrates the light. Condenser lens 30 condenses the light such that light travels through prism 32 and onto modulator 34.

Modulator 34 includes a micro-machine light modulator including electrostatically actuated optical cavities. Modulator 34 varies intensity and color modulation within each of a plurality of pixels. As will be described in greater detail hereafter, each pixel acts as a Fabry-Perot filter including a partial reflecting film, a tunable optical cavity and a strongly reflecting film. By controlling the size of each optical cavity, hues and intensities can be modulated without resorting to color wheels, dedicated pixels for each primary hue or polarized light. Interference from the two reflectors causes a narrow band filter that is used to select primary colors by varying the gap between the reflectors. The gap is controlled by balancing a flexure force and an electrostatic force between the two reflectors. As the gap is narrowed, absorption occurs and a black state can be achieved.

As indicated by arrow 42, light reflected from modulator 34 passes through prism 32 and through projection lens 36. Projection lens 36 includes a series of one or more optical lenses which focus and direct the light reflected from modulator 34 onto to a display surface (not shown).

Electron beam emitting device 38 includes a device configured to emit one or more electron beams at light modulator 34. As will be described in greater detail hereafter, electron beams emitted from electron beam emitting device 38 selectively charge at least one of the partially reflecting film and the strongly reflecting film of the pixels of light modulator 34 to adjust the electrostatic force between the two reflectors so as to control or vary the optical cavity between the reflectors to thereby vary the intensity and color modulation within each of the pixels. In one embodiment, electron beam emitting device 38 includes a cathode ray tube. In other embodiments, other electron beam emitting devices may be employed.

Controller 40 includes a processor unit configured to generate control signals to direct the operation of at least one light source 26, light modulator 34 and cathode ray tube 38. For purposes of the disclosure, the term “processor unit” shall include a conventionally known or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 40 is not limited to any specific combination of hardware circuitry and software, nor to any particular source for the instructions executed by the processing unit.

In the particular embodiment shown, controller 38 generates control signals based upon received image data. The control signals direct electron beam emitting device 38 to selectively charge pixels of light modulator 34 so as to tune the optical cavity of individual pixels based upon the image data such that the light reflected from each pixel of modulator 34 has a hue and intensity matching the image to be displayed. In particular embodiments, controller 40 may further generate control signals directing the supply of voltage to either of the reflectors of each pixel of light modulator 34 that is not charged by electron beam emitting device 34.

Although modulator 34 and electron beam emitting device 38 are illustrated as being incorporated into a display system 20 which includes a projector, modulator 34 and electron beam emitting device 38 may alternatively be incorporated into other display systems including televisions, computer monitors and other displays including wearable displays, cameras, cell phones, electronic paper, personal data assistance (PDAs), and the like.

FIG. 2 schematically illustrates an individual pixel 44 of light modulator 34. As shown by FIG. 2, each pixel 44 generally includes partial reflective layer 50, reflective member 52, shield 54 and resistor 56. Partial reflective layer 50 generally includes a layer of semi-reflective, semi-transparent material suspended relative to reflective member 52 to form optical cavity 60. Partial reflective layer 50 cooperates with reflective member 52 to reflect and or refract light so as to alter the wavelength of the light and to change its intensity and color. In the particular embodiment shown, partial reflective layer 50 is additionally electrically conductive and configured to retain charge, enabling layer 50 to be electrically biased to a voltage or charge to electrostatically actuate member 52 and to adjust optical cavity 60. In one embodiment, layer 50 may be formed from TaAl. In other embodiments, layer 50 may be formed from other material such as a wide range of metals, alloys and inter-metallics.

Reflective member 52 includes a relatively rigid member having a reflective surface 62. In the particular embodiment shown, member 52 has a surface 62 with a reflectivity of at least 90%. Reflective member 52 partially forms optical cavity 60 and is movably supported relative to layer 50. In one embodiment, member 52 may be movably supported relative to layer 50 by flexures. Movement of reflective member 52 adjusts or tunes a thickness of optical cavity 60 to vary optical interference within cavity 60 and to vary the intensity and color of light ultimately reflected from pixel 44. In the particular embodiment illustrated, surface 62 of member 52 is provided by AlCu. In other embodiments, other materials may be used to provide the reflective surface 62 of member 52 such as Al, Ag, Au and their alloys, dielectric and metal/dielectric composite thin film stacks.

As further shown by FIG. 2, member 52 includes an electrically conductive surface 64 configured to be impinged an electron beam (schematically represented by arrows 66). As a result, reflective member 52 may be charged by electron beam 66 so as to vary the voltage or charge of member 52 to also vary the electrostatic force between layer 50 and member 52. By varying the electrostatic force between layer 50 and member 52, the thickness of optical cavity 60 may be controlled.

Resistor 56 includes an electrical resistor electrically interconnecting conductive surface 64 of member 52 with layer 50. Resistor 56 has a sufficiently high resistance such that a resistor-capacitor circuit is formed by layer 50, member 52 and resistor 56. At the same time, resistor 56 is sufficiently conductive to permit charge on member 52 resulting from electron beam 66 to drain depending upon an RC time constant of pixel 44. In one embodiment, resistor 56 includes polysilicon electrically connected between layer 50 and member 52. In other embodiments, other materials or resistive components may be utilized.

Shield 54 includes an electrically conductive surface extending about and along a perimeter of pixel 44 between adjacent pixels 44. Shield 54 is electrically connected to ground 68. Shield 54 is configured to be impinged by electron beam 66 from electron beam device 38 as the electron beam moves from one pixel to an adjacent pixel. Shield 54 is configured to prevent electron beam 66 from impinging portions of pixel 44 other than member 52 as the electron beam is moved from pixel to pixel. Shield 54 drains the electron beam current to ground 68 off of the array of pixels 44.

In operation, electron beam device 38 emits and directs an electron beam 66 across the array of pixels 44 to selectively charge members 52 of the pixels 44. As electron beam device 38 moves electron beam 66 between adjacent pixels 44, electron beam 66 impinges shield 54 which drains such charge to ground 68. Partial reflectors 50 of pixels 44 are charged and maintained at a distinct voltage by one or more voltage sources 70. In other embodiments, reflectors 50 may be grounded. The difference between the charge or voltage on partial reflector 50 and the charge or voltage of member 52, created by the electron beam 66, creates an electrostatic field between partial reflector 50 and reflective member 52. This results in member 52 moving relative to reflector 50 to adjust the thickness of optical cavity 60 and to thereby adjust the intensity and color of light passing through partial reflector 50 and reflecting off of reflective member 52 of each pixel 44. Depending upon the electrical resistance of resistor 56 as well as the capacitance of reflector 50 and member 52, charge upon member 52 is drained, causing member 52 to move and return to an equilibrium position with respect to member 50 until member 52 is once again charged by electron beam 66.

Overall, pixels 44 of light modulator 34 enable the color intensity of reflected light to be controlled to provide a color image without using a color wheel. Because a color wheel which would otherwise absorb at least two-thirds of the light may be omitted, the intensity of the image provided by a projector using light modulator 34 may be enhanced. In addition, because each pixel 44 may be actuated and controlled using an electron beam from electron beam device 38, integrated circuitry, such as CMOS integrated circuitry may be omitted.

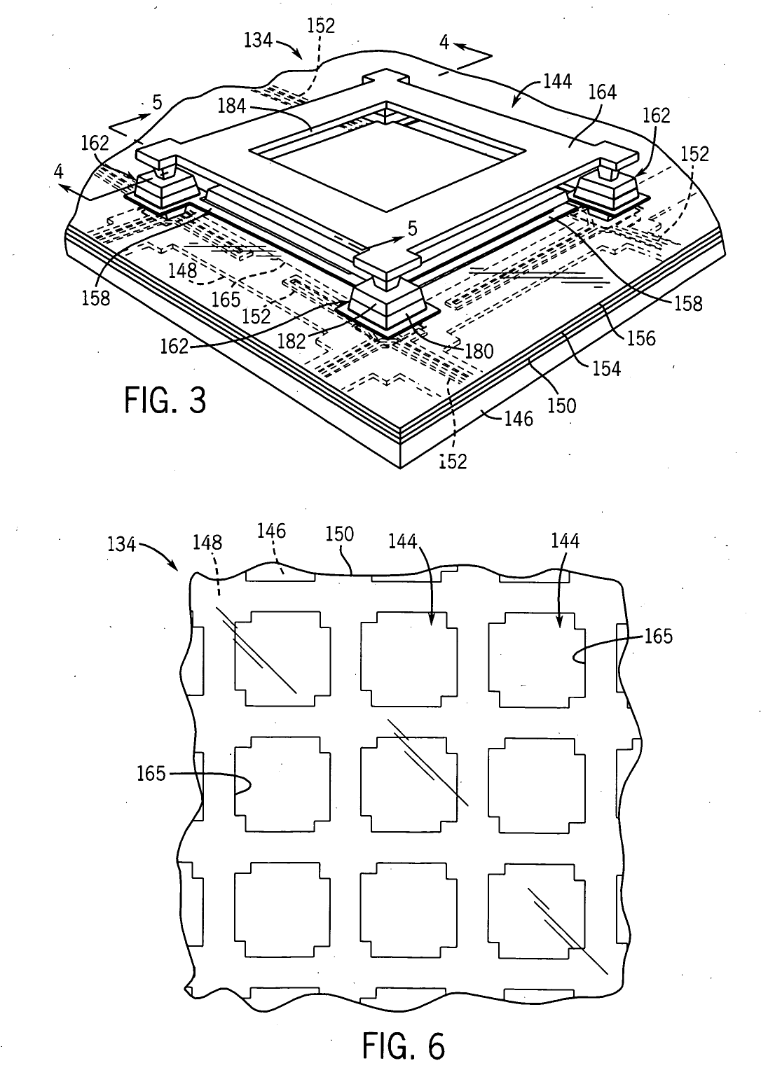

FIGS. 3-5 illustrate an individual pixel 144, one example of pixel 44 schematically shown in FIG. 2. As shown by FIGS. 3-5, pixel 144 generally includes substrate 146, hide layer 148, dielectric layer 150, resistors 152, dielectric layer 154, partial reflector 156, flexures 158, reflective member 160, shield support 162 and shield 164. Substrate 146 generally includes one or more layers of relatively rigid transparent material configured to support the remainder of pixel 144. In one embodiment, substrate 146 includes glass. In other embodiments, substrate 146 may comprise other transparent support materials, such as quartz.

Hide layer 148 includes one or more layers patterned across substrate 146 along the perimeters of and between pixels 44. Hide layer 148 is configured to absorb light between pixels 144 to reduce stray light and maximize contrast. In one embodiment, hide layer 148 includes 100 Angstroms of TaAl, 500 Angstroms of USG and 1000 Angstroms of AlCu, wherein the TaAl is positioned adjacent substrate 146. In other embodiments, hide layer 148 may be composed of other materials and may have alternative thicknesses.

Dielectric layer 150 overlies hide layer 148 and electrically insulates hide layer 148 from the remainder of pixel 144. In the particular embodiment illustrated, hide layer 150 includes a 2000 Angstroms thick layer of Tetraethyl Orthosilicate (TEOS) (Si(OC₂H₅)₄ which undergoes a chemical-mechanical planarization process to 1000 Angstroms to provide an optical flat surface for subsequent layers. In other embodiments, dielectric layer 150 may comprise one or more layers of other materials having differing thicknesses.

Resistor 142 includes a layer of electrically conductive, yet resistive material formed upon dielectric layer 150 and electrically connected to both partial reflector 156 and reflective member 160. Resistor 152 is formed from a material such that partial reflector 156 and reflective member 160 form a RC circuit and such that charge upon reflective member 160 may drain at a predetermined rate.

According to one embodiment, resistor 152 has a resistance of at least about 1×10⁸ (1e8) ohms, less than or equal to about 1×10¹⁰ ohms and nominally about 1×10⁹ ohms. In other embodiments, other resistive materials may be employed having other resistances.

In one particular embodiment, resistor 152 includes a serpentine pattern of polysilicon. According to one example embodiment, the pattern of polysilicon has a thickness of approximately 200 Angstroms. In such an embodiment, resistor 152 has a resistance of about 1×10⁹ ohms. In other embodiments, the length, thickness and conductivity of resistor 152 may be varied to modify the charge dissipation rate of the charge from reflective member 160.

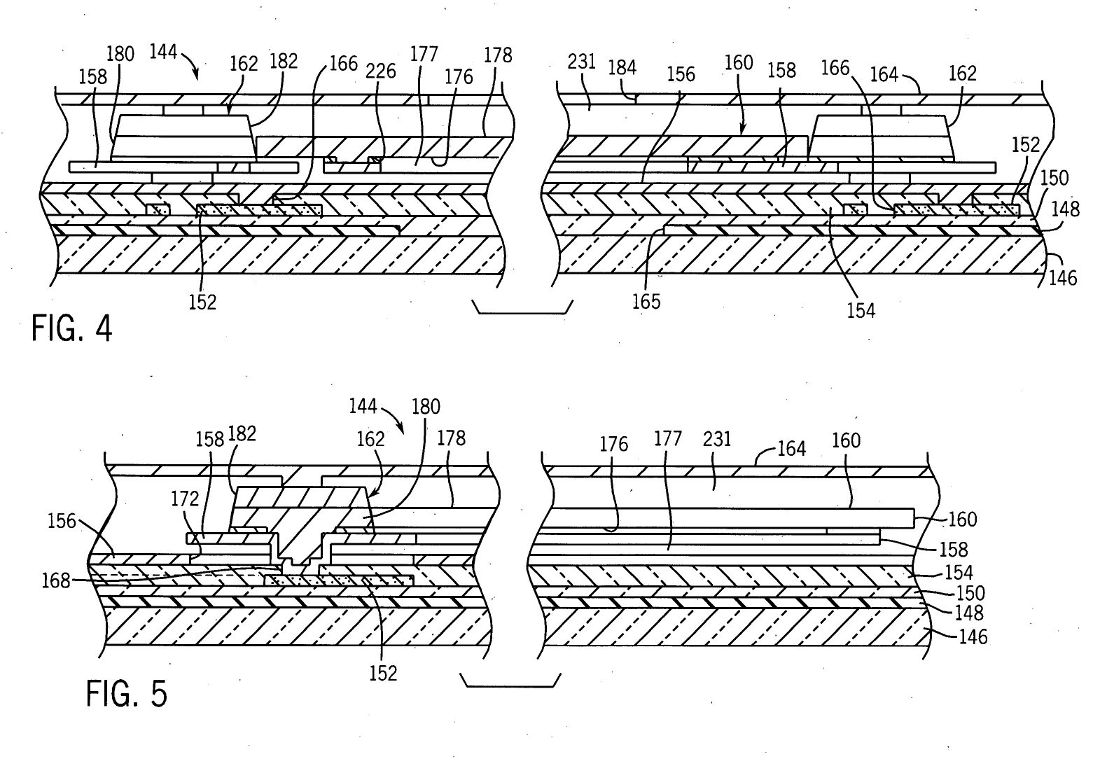

Dielectric layer 154 includes one or more layers of dielectric material disposed over layer 150 and over resistor 152. Dielectric layer 150 serves as a surface upon which partial reflector 156 is formed. Dielectric layer 154 includes via 166 (shown in FIG. 4) and via 168 (shown in FIG. 5) in communication with resistor 152 through which resistor 152 is electrically connected to partial reflector 156 and reflective member 160. For purposes of this disclosure, the term “via” means an electrical contact or connector. According to one example embodiment, dielectric layer 154 includes a layer of TEOS having a thickness of about 2000 Angstroms. In other embodiments, dielectric layer 154 may be comprised of one or more layers of one or more other materials and may have other thicknesses.

Partial reflector 156 includes one or more layers of electrically conductive semi-transparent, semi-reflective material formed and patterned upon dielectric layer 156. As shown by FIG. 4, partial reflector 156 extends into and at least partially fills via 166 so as to be in electrical contact with resistor 152. As further shown by FIG. 5, partial reflector 156 includes an enlarged opening or via 172 extending through the layer of material forming partial reflector 156 to via 168 which is in communication with resistor 152. Via 172 facilitates the electrical connection of flexure 158 and reflective member 160 to resistor 152 while electrically isolating flexure 158 and reflective member 160 from partial reflector 156 but through resistor 152.

According to one example embodiment, partial reflector 156 includes a layer of TaAl having a thickness of about 200 Angstroms. In one embodiment, partial reflector 156 continuously extends across each of pixels 144 and is maintained at a constant voltage. According to one example embodiment, partial reflector 156 continuously extends across the array of pixels 144 and is grounded outside of the array. In other embodiments, partial reflector 156 may be formed from one or more other materials that may have other thicknesses.

Flexures 158 comprise structures configured to movably support reflective member 160 relative to partial reflector 156 to vary optical cavity 174 formed therebetween. Flexures 158 are formed from materials and have appropriate directions so as to flex towards and away from partial reflector 156. In the embodiment shown, each of flexures 158 includes a flexible membrane, a thin pliable sheet of one or more materials. In one embodiment, each of flexures 158 generally has a stiffness of greater than 50 micro neutons per micrometer. In one embodiment, flexures 158 have a minimum stiffness of at least 7 micro neutons per micrometer. In one embodiment, each flexure 158 is formed from TaAl. In other embodiments, flexures 158 may be formed from other materials such as a wide range of metals, alloys and inter-metallics. In one embodiment, flexures 158 have a thickness of between about 1000 Angstroms and about 2000 Angstroms and nominally about 1500 Angstroms. In other embodiments, flexures 158 may have other dimensions.

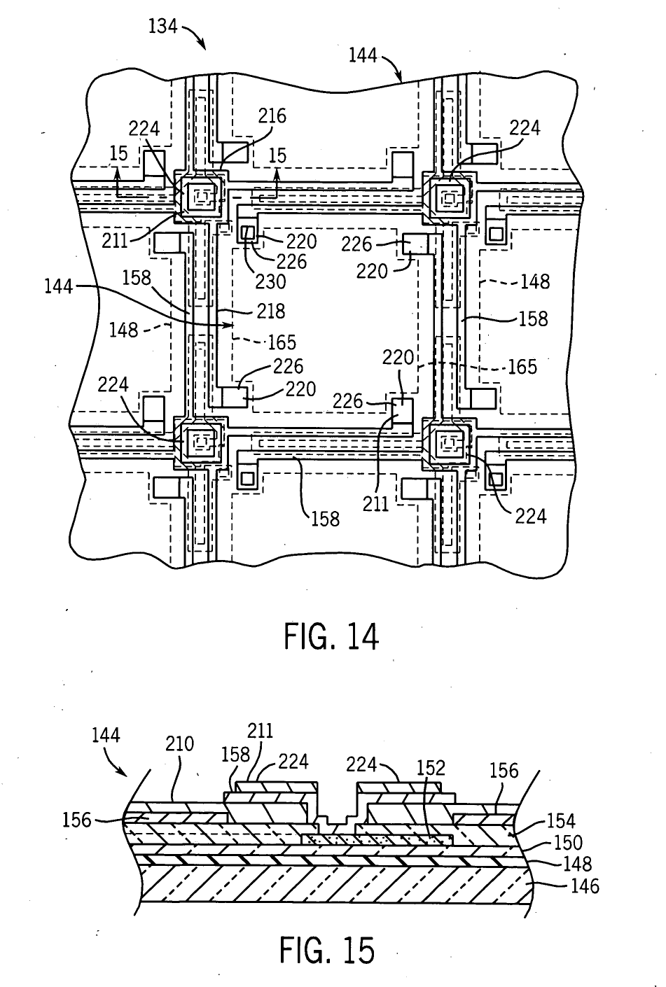

In the example embodiment shown, reflective member 160 is movably supported by four flexures 158 extending along each of four sides of reflective member 160. Three out of the four flexures provided for each reflective member 160 are electrically isolated from reflective member 160 such that electrical charge may be dissipated from reflective member 160 through one of flexures 158. In the example shown, a layer 211 (shown in FIG. 14) of flexure protect comprising oxide (not shown) is formed between the three flexures 158 and reflective member 160 to provide electrical isolation. In other embodiments, reflective member 160 may be electrically connected to resistor 152 by greater than a single flexure 158 and/or may be supported by a greater or fewer number of flexures 158 having other configurations. In other embodiments, electrical insulation of reflective member 160 from one or more of flexures 158 may be provided by dielectric or insulative materials at other locations.

Reflective member 160 includes one or more patterned layers of substantially reflective material extending across opening 165 of hide layer 148 and movably supported by flexures 158. Reflective member 160, also known as a pixel plate, includes a reflective surface 176 configured to substantially reflect light that is passed through substrate 146, through opening 165 and hide layer 148, through dielectric layers 150 and 154, and through partial reflector 156. Reflective member 160 additionally includes an electrically conductive surface 178 configured to receive or be impinged upon by an electron beam from an electron beam device such as a cathode ray tube. In one embodiment, reflective member 160 includes a layer of TaAl having a thickness of about 1000 Angstroms resting upon flexures 158 and a layer of AlCu having a thickness of about 5000 Angstroms upon the layer of TaAl. In other embodiments, reflective member 160 may be formed from one or more layers of other electrically conductive material and one or more layers of other reflective material.

Shield supports 162 comprise structures configured to support shield 164 spaced relative to reflective member 160. Supports 162 further electrically insulate shield 164 from flexures 158 and reflective member 160. Supports 162 extend from ends of flexures 168 to support perimeter portions of shield 164. In the particular example shown, support 162 includes a first portion 180 composed of substantially the same materials as reflective member 160 and a second portion 182 composed of one or more layers of dielectric material. In the example shown, portion 182 is formed from oxide having a thickness of about 10,000 Angstroms. In other embodiments, portion 182 may be formed from one or more layers of other dielectric materials. In still other embodiments, an entirety of each support 162 may be formed from dielectric materials or each support 162 may be provided with a layer of dielectric material at other locations between flexure 158 and shield 164.

Shield 164 includes one or more layers of electrically conductive material configured to inhibit charging of portions of pixels 44 other than reflective member 160 by an electron beam as the electron beam is moved from one pixel 144 to another pixel 144. In the particular example illustrated, shield 164 is further configured to drain charge from the electron beam to ground. Shield 164 extends about the perimeter of reflective member 160 and includes opening 165. Opening 184 generally includes a window overlying reflective member 160 through which an electron beam may pass to charge reflective member 160. In the example shown, window 184 is generally centered over reflective member 160 and has a width and a length less than the corresponding width and length of reflective member 160. In the particular example shown, shield 164 continuously extends across the entire array of pixels 144 of light modulator 134.

According to one example embodiment, shield 164 is formed from an electrically conductive material such as TaAl having a thickness of about 5000 Angstroms. Opening 184 has a length and a width of about 10 micrometers while reflective member 160 has a corresponding length and width of about 15 micrometers. Window 165 formed in hide layer 148 has a length and a width of each about 15 micrometers. In other embodiments, shield 164 may be formed from one or more layers of other electrically conductive materials and may have other thicknesses. In other embodiments, the dimensions of window 165, reflective member 160 and opening 184 may also be varied.

In operation, an electron beam 66 (shown in FIG. 2) impinges upon reflective member 160 to charge reflective member 160 to a desired voltage distinct from the voltage of charge upon partial reflector 156. As a result, the distinct charges upon reflective member 160 and partial reflector 156 to create an electrostatic field which may push or pull reflective member 160 relative to partial reflector 156 to vary the spacing or the optical cavity formed between reflective member 160 and partial reflector 156. Light passing through substrate 146, through window 165 of hide layer 148 and through partial reflector 156 reflects off of reflective member 160.

As an electron beam is moved from pixel 144 to an adjacent pixel 144, the electron beam 66 strikes shield 164. Charge from the electron beam is absorbed by shield 164 and is conducted to ground. After a pre-selected or predetermined amount of time, charge upon reflective member 160 drains through flexure 158 and through resistor 152 to partial reflector 156 which, according to one example embodiment, is maintained at ground. As a result, reflective member 160 returns to its equilibrium position with respect to partial reflector 156 until being recharged by electron beam 66.

According to one example embodiment, reflective member 160, partial reflector 156 and resistor 152 form a RC circuit in which reflective member 160 has an RC time constant of at least about 5e−7 sec, no greater than 5e−5 sec and nominally about 5e−6 sec. In other embodiments, resistor 152 may be varied to vary the RC time constant and the rate at which charge from reflective member 160 drains.

FIGS. 6-21 illustrate one example process for forming an array of pixels 144 of light modulator 134. As shown by FIG. 6, hide layer 148 is initially formed upon substrate 146. According to one example embodiment, 100 Angstroms of TaAl are initially deposited upon substrate 146, followed by the deposition of 500 Angstroms of USG and further followed by 1000 Angstroms of AlCu. Thereafter, the layers are patterned and etched to form windows 165. Dielectric layer 150 is subsequently deposited upon hide layer 148. In the example, dielectric layer 150 has initial thickness of about 2000 Angstroms and is CMP to a thickness of about 1000 Angstroms which provides an optically flat surface layers. In other embodiments, hide layer 140 may be formed from one or more layers of other materials. In addition, hide layer 148 and dielectric layer 150 may have other thicknesses.

FIG. 7 illustrates the formation of resistors 152 and dielectric layer 154. In particular, a continuous layer of a resistive material, such as polysilicon, is deposited across dielectric layer 150 and is subsequently patterned and etched to form resistors 152. Each resistor includes a pair of pads 202, 204 connected by a serpentine portion 206 of resistor material. Each resistor 152 is formed so as to overlie hide layer 148 along the perimeter of each pixel 144 and along and between adjacent windows 165 of hide layer 148.

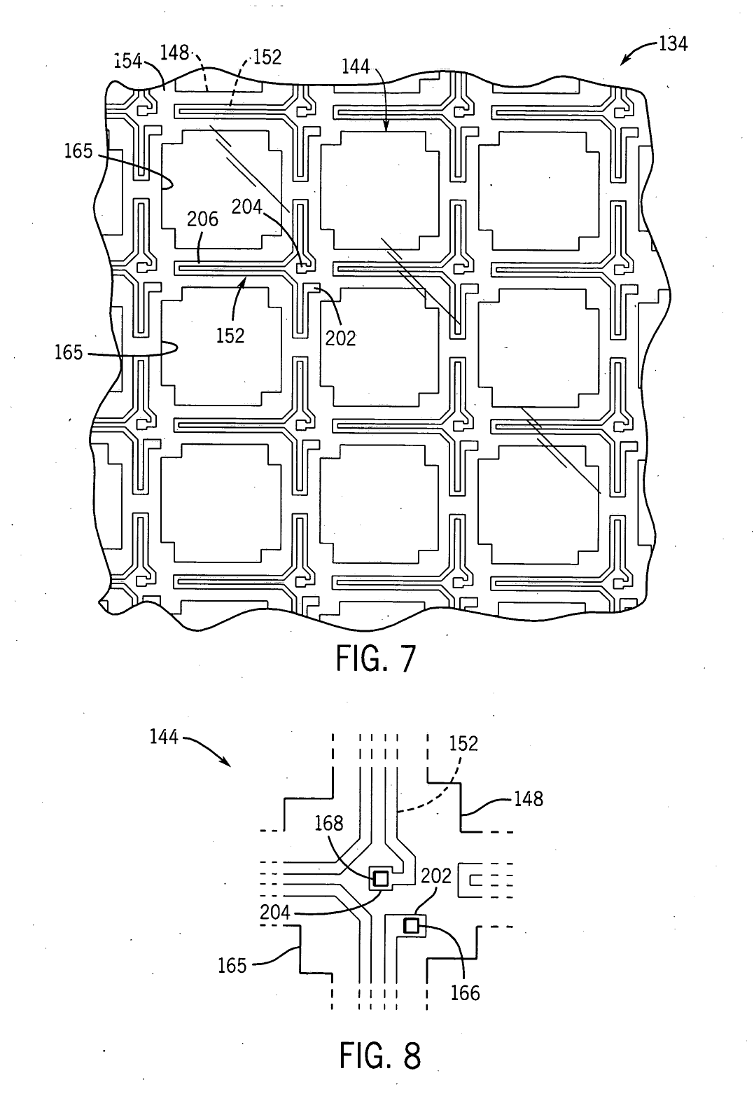

Thereafter, dielectric layer 154 is deposited over resistors 152. As shown by FIG. 8, dielectric layer 154 is patterned so as to form vias 166 and 168 which extend through layer 154 to paths 202 and 204 of resistor 152, respectively.

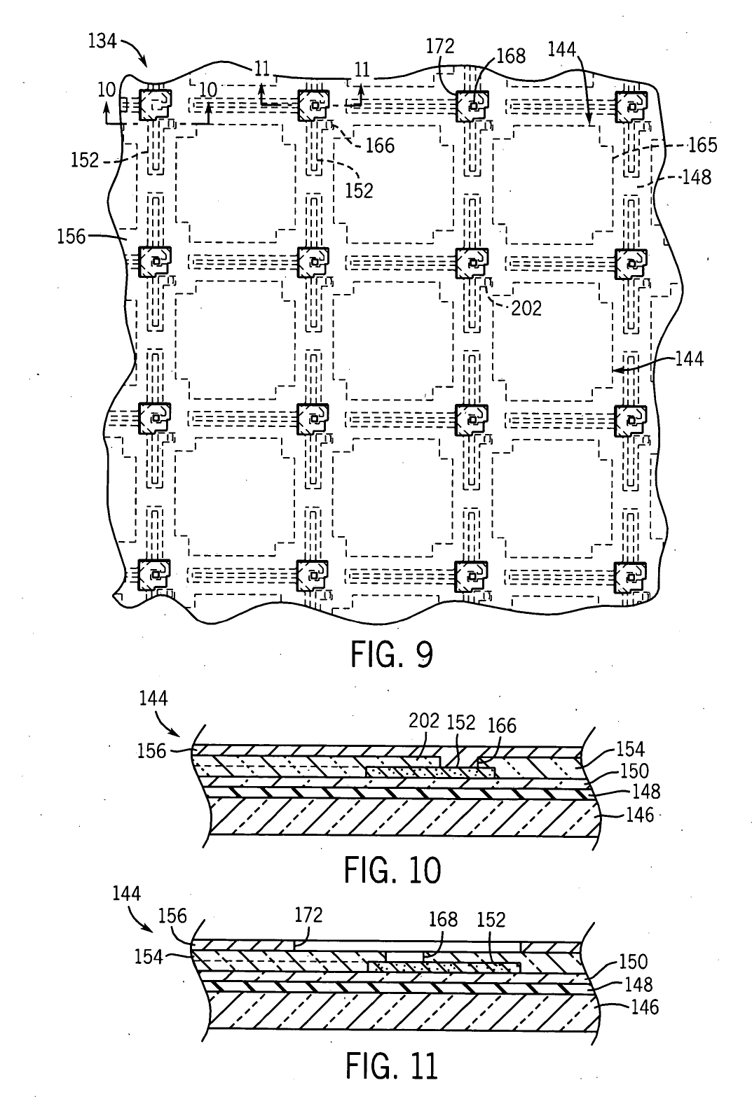

FIGS. 9-10 illustrate the further formation of partial reflector 156 for pixels 144. In particular, a continuous layer of partially reflective material, such as TaAl, is deposited upon dielectric layer 154. As shown by FIG. 10, the partially reflective, electrically conductive material of partial reflector 156 at least partially fills via 166 to be in electrical contact with pad 202 of resistor 152. As shown by FIG. 11, a continuous layer of partially reflective, electrically conductive material forming partial reflector 156 is further patterned and etched to form openings 172 over and above via 168 which is not filled with the material of partial reflector 156.

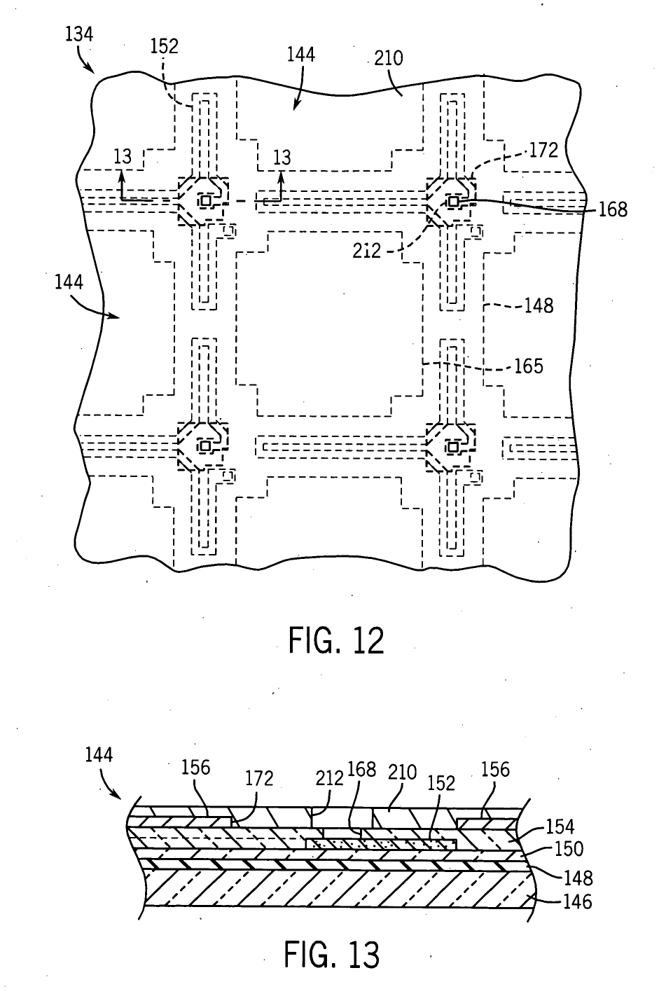

FIGS. 12 and 13 illustrate the formation of sacrificial layer 210 upon partial reflector 156. Sacrificial layer 210, upon a release etch, forms a spatial gap between partial reflector 156 and reflective member 160. This spatial gap provides optical cavity 177 (shown in FIG. 4) that changes in size to absorb or reflect different wavelengths of light. As shown by FIG. 13, sacrificial layer 210 is patterned and etched so as to extend along partial reflector 156 about opening 172 and so as to form a via 212 through layer 210 narrower than opening 172 and in communication with via 168 of dielectric layer 154. As shown by FIG. 12, sacrificial layer 210 continuously and substantially overlies a remainder of the array of pixels 144. In particular, sacrificial layer 210 overlies partial reflector 156 that is aligned with window 165 in hide layer 148. According to one example embodiment, sacrificial layer 210 comprise a layer of amorphous silicon having a thickness of about 8000 Angstroms. In other embodiments, one or more layers of other materials having other thicknesses may be employed for sacrificial layer 210.

FIGS. 14 and 15 illustrate the formation of flexures 158. Initially, a layer of transparent electrically conductive material 211, deposited across sacrificial layer 210. Thereafter, a layer of dielectric material is blanket deposited or otherwise formed upon the layer of transparent electrically conductive material. In one embodiment, the layer of transparent electrically conductive material forming flexures 158 includes TaAl has a thickness of about 1500 Angstroms and the layer 211 of dielectric material includes oxide having a thickness of about 2000 Angstroms. After deposition of electrically conductive and dielectric layers, such layers are patterned with a flexure mask having the configuration of flexures 158. The transparent electrically conductive layer and the dielectric layer are both then etched or otherwise removed.

A flexure protect mask is subsequently patterned over selected portions of flexures 158. Thereafter, the remaining portions of the dielectric layer 211 overlying portions of the transparent electrically conductive layer of flexure 58 is etched away.

As a result of the aforementioned process, each flexure 58 has a configuration shown in FIG. 14. In particular, each flexure 58 generally includes a base portion 216, a leg portion 218 and a foot portion 220. Base portion 216, leg portion 218 and foot portion 220 extend above or are otherwise aligned with hide layer 148. Foot portion 220 projects towards window 165 so as to be configured to support reflective member 160 once formed. As shown by FIG. 15, portion 224 of layer 211 remains extended over each base portion 216 so as to protect the transparent, electrically conductive material of flexure 58 during subsequent etching steps. As shown by FIG. 14, feet 220 of three of flexures 158 are additionally coated with portion 226 of layer 211. One of flexures 158 has a patterned via 230 through the portion 226 of layer 211. Via 230 facilitates the electrical connection of the associated flexure 158 to reflective member 160 (shown in FIG. 3) once formed.

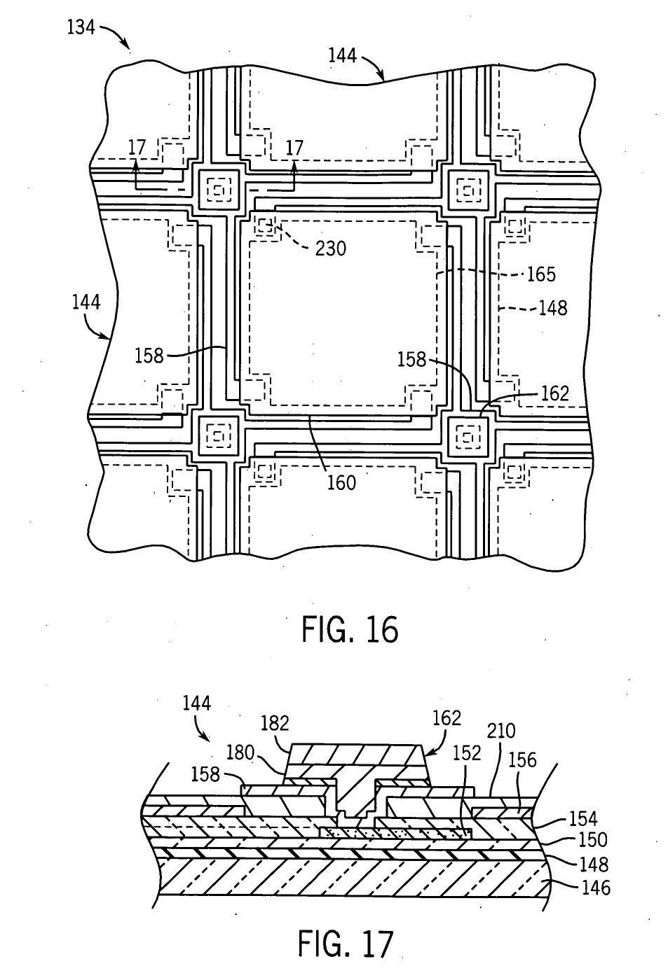

FIGS. 16 and 17 illustrate the formation of reflective member 160 and shield support 162. In particular, one or more layers of reflective electrically conductive material are initially deposited across the array of pixels 144 over sacrificial layer 210 and over flexures 158. Thereafter, a layer of dielectric material is blanket deposited over the one or more layers of reflective electrically conductive material. According to one embodiment, the one or more layers of reflective electrically conductive material comprise a layer of AlCu having a thickness of about 5000 Angstroms and a layer of TaAl having a thickness of about 1000 Angstroms. The one or more layers of dielectric material includes a layer of oxide having a thickness of about 10000 Angstroms. Once such layers are formed, such layers are patterned and etched to remove each of such layers except for those layers overlying window 165 of hide layer 148 (generally between the four flexures 158) and those layers overlying base portion 216 of each of flexures 158. Subsequently, a mask is applied and the one or more layers of dielectric material is etched away from reflective member 160. As a result, reflective member 160 includes the one or more layers of reflective electrically conductive material. As shown by FIG. 15, shield support 162 includes portion 180 composed of the one or more layers of reflective electrically conductive materials and portion 182 composed of the one or more layers of dielectric material. As noted above, portion 182 electrically insulates reflective member 160 from shield 164 (shown in FIG. 3) once formed. Reflective member 160 reflects light and also receives charge from an electron beam.

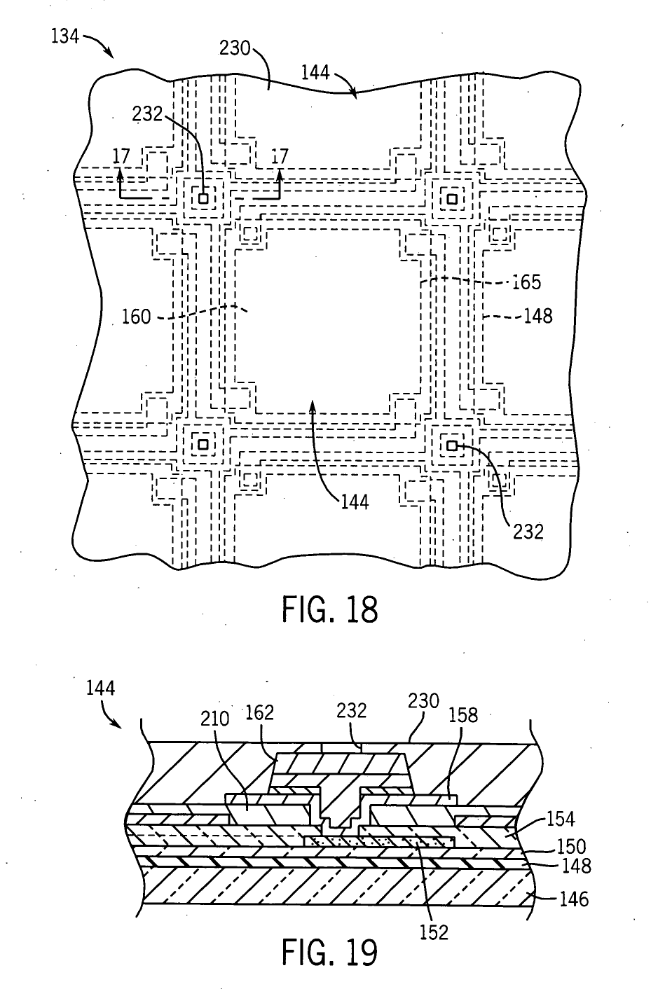

FIGS. 18 and 19 illustrate the deposition of sacrificial layer 230. As shown by FIG. 16, sacrificial layer 230 is blanket coated or continuously deposited across the array of pixel 144 upon sacrificial layer 210, upon flexure 158, upon shield support 162 and upon reflective member 160. As shown by FIGS. 18 and 19, sacrificial layer 230 is patterned and etched so as to form vias 232 which extend through layer 230 to shield supports 162. According to one example embodiment, sacrificial layer 230 includes a layer of amorphous silicon having a thickness of about 15000 Angstroms. In other embodiments, other sacrificial materials having other thicknesses may be employed. Sacrificial layer 230, upon being removed by a subsequent release etch, forms a spatial gap 231 (shown in FIG. 4) between shield 164 and reflective member 160.

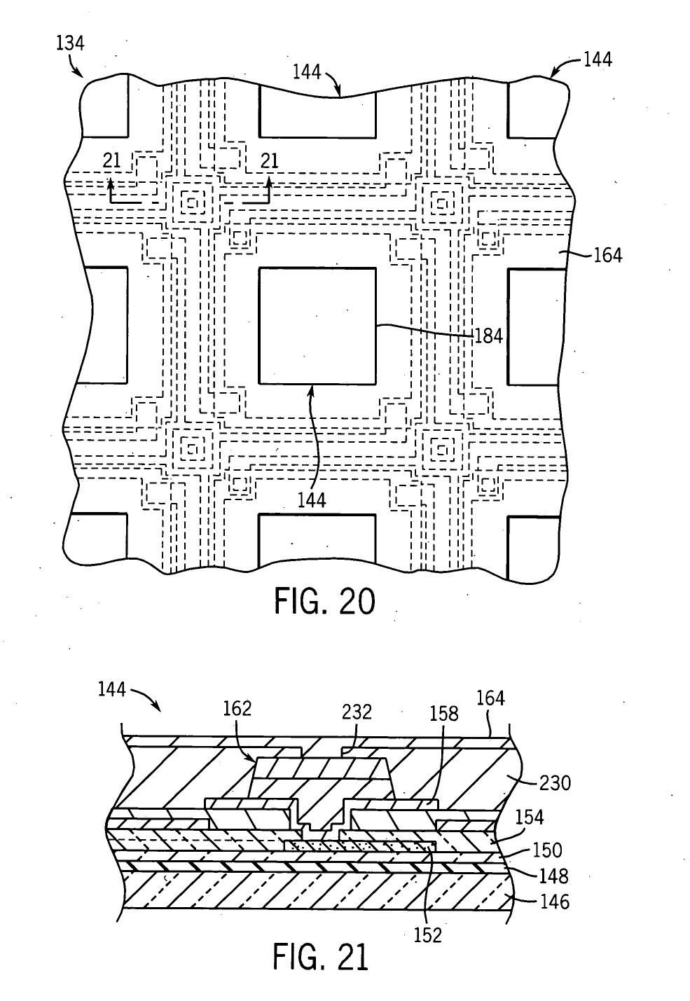

FIGS. 20 and 21 illustrate the formation of shield 164. As shown by FIG. 20, shield 164 is formed by blanket coating or otherwise depositing a continuous layer of electrically conductive material over and upon the layer of pixels 144. This layer is patterned and etched so as to form windows 184 which overlie reflective members 160 and windows 165 of hide layer 148. As noted above, shield 164 is configured to block electron beams from contacting any components below reflective members 160. Shield 184 is further configured to absorb and drain any charge from impinging electron beams to ground. According to one example embodiment, shield 164 is formed from a layer of TaAl having a thickness of about 5000 Angstroms. In other embodiments, shield 164 may be formed from other electrically conductive materials having other thicknesses.

As shown by FIG. 21, the electrically conductive material of shield 164 fills via 232 so as to contact shield support 162, allowing shield support 162 to support shield 164 upon a subsequent release etch.

FIGS. 4 and 5 illustrate pixel 144 of FIG. 20 after a release etch has been applied to pixel 144 to remove sacrificial layers 210 and 230 (shown in FIG. 21). As shown by FIGS. 4 and 5, upon the release etch, shield 164 is supported by shield supports 162 while being spaced above reflective member 160. Reflective member 160 is movably supported by flexures 158 while being spaced from partial reflector 156 to form optical cavity 176. Optical cavity is generally positioned and aligned between window 165 of hide layer 148 and window 184 of shield 164.

As further shown by FIG. 5, reflective member 160 is electrically connected to resistor 152 through one of flexures 158 and through via 168. As shown by FIG. 4, partial reflector 156 is electrically connected to resistor 152 through via 166. As a result, charge is permitted to drain from reflective member 160 to partial reflector 156 and to ground through resistor 152.

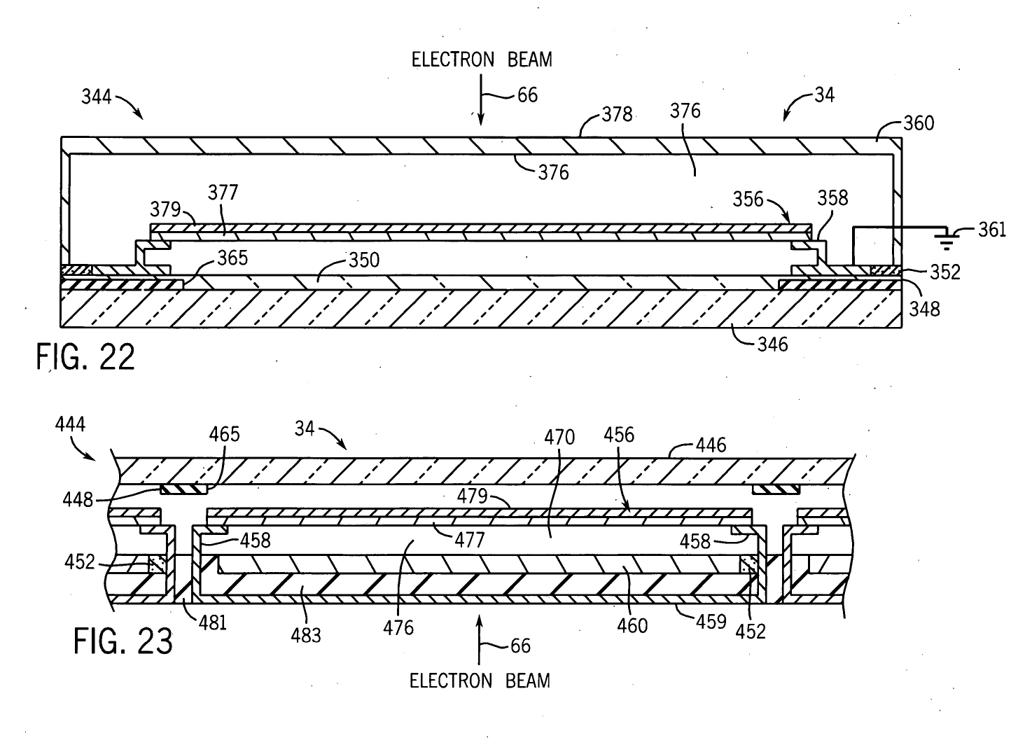

FIG. 22 is a sectional view schematically illustrating pixel 344, an alternative embodiment of pixel 144 for use as part of an array forming light modulator 34. Pixel 344 generally includes substrate 346, hide layer 348, resistor 352, partial reflector 356, flexure 358, and reflective member 360. Substrate 346 continuously extends beneath and supports the array of pixels 344. Substrate 346 is formed from a transparent material such as glass. In other embodiments, substrate 346 may be formed from other materials.

Hide layer 348 includes one or more layers of opaque or light absorbing material formed upon substrate 346 and including window 365. Window 365 permits light to pass through substrate 346 and through partial reflector 356 so as to be reflected by reflective member 360. At the same time, hide layer 348 absorbs light between adjacent pixels 344 to reduce stray light and maximize contrast. According to one example embodiment, hide layer 348 may be formed from a lower layer of TaAl having a thickness of about 100 Angstroms, an intermediate layer of USG having a thickness of about 500 Angstroms and an upper layer of AlCu having a thickness of about 1000 Angstroms. In other embodiments, hide layer 365 may be formed from other materials having different thicknesses.

Dielectric layer 350 includes a layer of transparent dielectric material overlying hide layer 348 and window 365. Dielectric layer 350 electrically insulates hide layer 348 from flexures 358. According to one embodiment, dielectric layer 350 includes a layer of TEOS having a thickness of about 1000 Angstroms. In other embodiments, dielectric layer 350 may be formed from other dielectric materials having other thicknesses.

Resistor 352 includes a layer of resistive material formed upon dielectric layer 350 and configured to electrically connect at least one of flexure 358 with reflective member 360. According to one embodiment, resistor 352 includes a layer of polysilicon. In other embodiments, resistor 352 may be formed from other electrically conductive, but resistive materials. Resistor 352 facilitates draining of electrical charge from reflective member 360 to ground 361.

Flexures 358 comprise electrically conductive transparent structures configured to movably support partial reflector 356 relative to reflective member 360. Flexures 358 are electrically connected to resistors 352 and are further electrically connected to ground 361. In one embodiment, flexures 358 are formed from TaAl. In other embodiments, other transparent electrically conductive materials may be employed for flexures 358.

Partial reflector 356 includes one or more layers of semi-transparent, semi-reflective material and one or more layers of electrically conductive material movably supported by flexures 358 to adjust a thickness of optical cavity 376. In the example embodiment, partial reflector 356 is electrically connected to ground 361. In the exemplary embodiment, partial reflector 356 includes semi-transparent, semi-reflective electrically conductive layer 377 and stiffening layer 379. In one embodiment, layer 377 is formed from TaAl while stiffening layer 379 is formed from a rigid stiffening material such an oxide. In other embodiments, layers 377 and 379 may be formed from other materials that are semi-reflective, semi-transparent and electrically conductive.

Reflective member 360 includes one or more layers of material having a reflective surface 376 and an electrically conductive surface 378. Surface 376 is configured to substantially reflect at least 90% of light impinging upon it. Surface 378 includes an electrically conductive surface configured to absorb electron beam 66 such that reflective member 360 may be electrically charged by electron beam 66. Electrically conductive surface 378 is electrically connected to flexure 358 and the electrically conductive portion of partial reflector 356 by resistor 352. As a result, reflective member 360, partial reflector 356 and resistor 352 form a resistive-capacitance circuit, allowing charge to be drained from reflective member 360 to ground 361 at a predetermined rate depending upon the RC time constant of the formed RC circuit. According to one example embodiment, reflective member 360 includes a layer of AlCu underlying a layer of TaAl. In other embodiments, reflective member 360 may be formed from one or more layers of one or more other materials.

In operation, electron beam 66 impinges reflective member 360 to charge reflective member 360 to a predetermined voltage so as to form an electrostatic field between reflective member 360 and partial reflector 356. The electrostatic field pulls or pushes partial reflector 356 to vary the thickness of optical cavity 376 and to correspondingly vary the wavelength of light emitted from pixel 344. Over time, charge upon reflective member 360 drains through resistor 352 to ground 361 such that the electrostatic field between reflective member 360 and partial reflector 356 diminishes, allowing partial reflector 356 to retain to an equilibrium position until reflective member 360 is once again charged by electron beam 66.

FIG. 23 illustrates pixel 444, another embodiment of pixel 144. Pixel 444 is part of an array of pixels 444 of modulator 34. Pixel 444 generally includes substrate 446, hide layer 448, partial reflector 456, flexures 458, electrically conductive surface 459, reflective member 460 and resistor 452. Substrate 446 includes one or more layers of transparent rigid material configured to support hide layer 448. In one embodiment, substrate 446 includes a layer of glass. In other embodiments, substrate 446 may comprise other transparent materials.

Hide layer 448 includes one or more layers of light-absorbing or opaque material formed upon substrate 446 and patterned so as to extend between adjacent pixels 444. Hide layer 448 absorbs light between pixels 444 to reduce stray light and maximize contrast. In one embodiment, hide layer 448 may comprise multiple layers including a layer of TaAl adjacent substrate 446, an intermediate layer of USG and a layer of AlCu. In other embodiments, hide layer 448 may be formed from one or more other layers of one or more other materials. Substrate 446 and hide layer 448 are spaced from partial reflector 446 by a gap 470, enabling partial reflector 456 to move between reflector 460 and substrate 446.

Partial reflector 446 includes one or more layers of semi-transparent, semi-reflective and electrically conductive material movably supported between substrate 446 and reflective member 460. In one embodiment, partial reflector 456 includes layer 477 of semi-transparent, semi-reflective electrically conductive material, such as TaAl, and a stiffening layer 479 such as an oxide. In other embodiments, partial reflector 456 may be formed from one or more layers of other materials.

Flexures 458 comprise structures configured to movably support partial reflector 456 relative to reflective member 460. At least one of flexures 458 is electrically conductive and is electrically connected to electrically conductive surface 459. According to one example embodiment, flexures 458 are formed from TaAl and movably support partial reflector 456 relative to reflective member 460 so as to vary the optical cavity 476 therebetween.

Electrically conductive surface 459 includes one or more layers of electrically conductive material configured to be impinged upon by electron beam 66 so as to transfer charge to layer 477 of partial reflector 456. As shown by FIG. 23, electrically conductive surface 459 is electrically isolated from electrically conductive surface 459 of adjacent pixel 444 by dielectric layer 481 and is electrically insulated from reflective member 460 by dielectric layer 483.

Reflective member 460 includes one or more layers of reflective material configured to reflect at least 90% of light. Reflective member 460 extends generally opposite to partial reflector 456 so as to form optical cavity 476. Reflective member 460 is electrically isolated from flexures 458 and electrically conductive member 459 except through resistor 452. In one embodiment, reflective member 460 is electrically connected to a ground at a perimeter of the array of pixels 444.

Resistor 452 includes a layer of resistive material electrically connected between one of flexures 458 and reflective member 460. Resistor 452 is electrically coupled between partial reflector 456 and reflective member 460 so as to form a RC circuit, allowing charge from partial reflector 456 to be drained to reflective member 460 and to ground. According to one example embodiment, resistor 452 includes a layer of polysilicon. In other embodiments, resistor 452 may be formed from other materials configured to allow electrical charge to be drained at a predetermined rate from partial reflector 456.

In operation, electron beam 66 is directed across the array of pixels 444 to selectively impinge upon electrically conductive surfaces 459 so as to correspondingly charge layer 477 of partial reflectors 456. The charging of partial reflectors 456 creates an electrostatic force between partial reflector 456 and reflective member 460 which moves partial reflector 456 relative to reflective member 460 so as to vary the thickness of optical cavity 476. Light directed at pixel 444 passes through substrate 446 through each window 465, through partial reflector 456 until it is reflected from reflective member 460. The thickness of optical cavity 476 controls the wavelength of light reflected from each pixel 444. After a predetermined period of time, charge upon partial reflector 456 drains to ground through resistor 452, producing the electrostatic force between partial reflector 456 and reflective member 460 and allowing partial reflector 456 to return to an equilibrium state until once again charged by electron beam 66.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a partial reflective layer;
a first reflective member movably supported relative to and spaced from the layer; and
a first electrically conductive surface electrically coupled to at least one of the partial reflective layer and the first reflective member and configured to be impinged upon by an electron beam.

2. The apparatus of claim 1 further comprising:
an electron beam emitting device configured to impinge the surface with an electron beam.

3. The apparatus of claim 2, wherein the first reflective member has a first face opposite the partial reflective layer and a second opposite face, and wherein the electron beam emitting device is configured to impinge the second face with an electron beam.

4. The apparatus of claim 1 including a transparent substrate upon which the partial reflective layer is located.

5. The apparatus of claim 4, wherein the substrate comprises glass.

6. The apparatus of claim 1, wherein the partial reflective layer is electrically conductive.

7. The apparatus of claim 1 including at least one flexure movably supporting the first reflective member relative to the partially reflective layer.

8. The apparatus of claim 7, wherein the at least one of the flexures is electrically conductive.

9. The apparatus of claim 1 including an opaque layer about the partial reflective layer.

10. The apparatus of claim 1 including a light source configured to direct light through the partial reflective layer and at the first reflective member.

11. The apparatus of claim 1 including at least one lens through which reflected light from the first reflective member passes.

12. The apparatus of claim 1 further comprising:
an electron beam emitting device; and
a controller configured to generate control signals, wherein the electron beam emitting device selectively charges the first reflective member in response to the control signals.

13. The apparatus of claim 1 further comprising:
an electron beam emitting device; and
a controller configured to generate control signals, wherein the electronic beam emitting device selectively charges the first reflective member in response to the control signals.

14. The apparatus of claim 1 including a voltage source configured to electrically bias the partial reflective layer to a predetermined voltage.

15. The apparatus of claim 1 further comprising:
a second reflective member movably supported relative to and spaced from the partial reflective layer; and
a second electrically conductive surface coupled to the partial reflective layer and the second reflective member and configured to be impinged upon by an electron beam.

16. The apparatus of claim 15 further comprising an electrically conductive shield between the first electrically conductive surface and the second electrically conductive surface.

17. The apparatus of claim 15 further comprising:
an electron beam emitting device; and
a controller configured to generate control signals, wherein the electron beam emitting device selectively charges the first reflective member and the second reflective member.

18. The apparatus of claim 1 further comprising a resistor electrically connecting the partial reflective layer and the first reflective member.

19. The apparatus of claim 1, wherein the first electrically conductive surface is opposite the first reflective member and wherein the first reflective member is between the first electrically conductive surface and the partial reflective layer.

20. An apparatus comprising:
a first reflector and a second reflector forming an optical cavity therebetween; and
an electron beam emitting device configured to emit an electron beam, wherein the second reflector moves relative to the first reflector in response to the emitted electron beam.

21. An electronic device comprising:
a plurality of pixels, each pixel including a first reflective layer and a second reflective layer forming an optical cavity therebetween;
at least one electron beam emitting device; and
a controller configured to generate control signals, when the electron beam emitting device selectively directs an electron beam to selectively modify one of the plurality of pixels in response to the control signals.

22. The device of claim 21, wherein the electron beam emitting device is configured to selectively direct the beam so as to charge one of the pixels.

23. An apparatus comprising:
a first reflector and a second reflector forming an optical cavity therebetween; and
means for moving the second reflector relative to the first reflector using an electron beam.

24. A method comprising:
creating a first charge on a partial reflective layer; and
creating a second charge on a first reflective member opposite the partially reflective layer with an electron beam to electrostatically move the reflective member relative to the partially reflective layer.

25. The method of claim 24 further comprising charging the first reflective member using an electron beam.

26. The method of claim 24 further comprising dissipating charge from the first reflective member.

27. The method of claim 24 further comprising directing light through the partially reflective layer against the first reflective member.

28. The method of claim 24 further comprising creating a third charge on a second reflective member opposite the partial reflective layer with an electron beam to electrostatically move the second reflective member relative to the partial reflective layer.

29. A method comprising:
creating a first charge on a first reflective member between and opposite to a partial reflective layer and a first electrically conductive layer; and
creating a second charge on the first electrically conductive layer with an electron beam to electrostatically move the first reflective member relative to the partial reflective layer.

30. The method of claim 29 further comprising directing light through the partial reflective layer against the reflective member.

31. The method of claim 29 further comprising:
creating a third charge upon a second reflective member between and opposite to the partial reflective layer and the second electrically conductive layer; and
creating a fourth charge on the second electrically conductive layer with an electron beam to electrostatically move the second reflective member relative to the partial reflective layer.

32. A method comprising:
providing a partial reflective layer; and
forming a reflective member spaced from and movable relative to the partial reflective layer, wherein the reflective member is electrically coupled to a surface configured to be impinged by an electron beam.

33. The method of claim 32, wherein the reflective member has a first face opposite the partial reflective layer and a second opposite face providing the surface.

34. A method comprising:
providing a partially reflective layer;
providing a reflective member spaced from and movable relative to the partial reflective layer; and
forming an electrically conductive layer opposite the reflective member and electrically coupled to a surface configured to be impinged by an electron beam.

35. The method of claim 34, wherein the reflective member has a first face opposite the reflective member and a second opposite face providing the surface.

36. An electronic device for at least partially displaying a pixel of a displayable image comprising:
a first reflector and a second reflector defining an optical cavity therebetween and selective of an electromagnetic wavelength at an intensity by optical interference;
at least one cathode ray charge controlling mechanism configured to allow optical properties of the optical cavity to be varied by controlling a predetermined amount of charge stored on the first and second reflectors such that at least one of electromagnetic wavelength or intensity are variably selectable in correspondence with the pixel and displayable image.
